(19) United States
(12) Patent Application Publication
(10) Pub. No.: US 2025/0200890 A1
(43) Pub. Date: Jun. 19, 2025

(54) PRISM VOLUMES FOR DISPLACED SUBDIVIDED TRIANGLES

(71) Applicants: ADVANCED MICRO DEVICES, INC., Santa Clara, CA (US); ATI TECHNOLOGIES ULC, Markham (CA)

(72) Inventors: Andrew Erin Kensler, Bellevue, WA (US); David William John Pankratz, Toronto (CA); David Kirk McAllister, Holladay, UT (US); David Ronald Oldcorn, Milton Keynes (GB); Holger Gruen, Munich (DE)

(21) Appl. No.: 18/540,234

(22) Filed: Dec. 14, 2023

(51) Int. Cl. G06T 17/10; G06T 1/20; G06T 15/06; G06T 17/20

(52) U.S. Cl. CPC G06T 17/10; G06T 1/20; G06T 15/06; G06T 17/20; G06T 2210/12; G06T 2210/21

(57) ABSTRACT

To perform ray traversals of displaced micro-meshes (DMMs), a processing system includes an accelerator unit (AU). The AU is configured to first generate a DMM including one or more base triangles. The AU then generates an initial bounding volume around a first base triangle of the DMM. Further, the AU bounds one or more sides of the initial bounding volume with respective bounding volumes to produce a prism bounding volume around the base triangle. The AU is then configured to determine whether a ray intersects the prism volume bounding the first base triangle of the DMM.

### BACKGROUND

Some processing systems render primitives for a scene to be displayed by implementing ray tracing techniques that determine whether rays from light sources within the scene intersect with the primitives of the scene. To determine whether the rays intersect the primitives, the processing systems generate and traverse acceleration structures, such as bounding volume hierarchies (BVHs), that each represents a hierarchy of bounding volumes within the scene. However, such acceleration structures consume a significant amount of memory. Furthermore, due to the size of each acceleration structure, the processing systems require a substantial amount of time to traverse the acceleration structure which increases the time and processing resources needed to render primitives for the scene, lowering the processing efficiency of the processing systems.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system configured to perform ray tracing operations using a prism volume hierarchy indicated by a displaced micro-mesh (DMM), in accordance with some embodiments.

FIG. 2 is a flow diagram of an example operation for generating a DMM, in accordance with some embodiments.

FIG. 3 is a block diagram of a base triangle recursively divided into hierarchical levels of sub-triangles, in accordance with some embodiments.

FIG. 4 is a block diagram of a displaced triangle in a DMM, in accordance with some embodiments.

FIG. 5 is a block diagram of a DMM, in accordance with some embodiments.

FIG. 6 is a flow diagram of an example operation for generating prism volumes that bound triangles of a DMM, in accordance with some embodiments.

FIGS. 7 and 8 together present a block diagram of an example initial bounding volume, in accordance with some embodiments.

FIG. 9 is a block diagram of a prism volume, in accordance with some embodiments.

FIG. 10 is a block diagram of an example prism volume hierarchy, in accordance with some embodiments.

FIG. 11 is a flow diagram of an example operation for ray tracing using a prism volume, in accordance with some embodiments.

FIG. 12 is a flow diagram of an example method for ray tracing using generated prism volumes based on a DMM, in accordance with some embodiments.

### DETAILED DESCRIPTION

To help render primitives in a scene to be displayed, some processing systems implement ray tracing operations that help simulate light reflections, refractions, and shadows within the scene. These ray tracing operations, for example, include a processing system determining which primitives of a scene intersect with one or more rays from one or more sources within the scene. To this end, the processing system uses an acceleration structure that includes, for example, a data structure that has two or more nodes (e.g., boxes, leaves) with each node representing a bounding volume. For example, an acceleration structure includes structures such as a bounding volume hierarchy (BVH). The bounding volumes included in an acceleration structure each represent a partition (e.g., closed volume) of at least a portion of the scene that contains one or more primitives, objects, or both of the scene and includes, for example, an axis-aligned bounding box (AABB), oriented bounding box (OBB), bounding shape (e.g., capsule, cylinder, ellipsoid, sphere, slab, triangle), or discrete oriented polytope (DOP), to name a few. Within the acceleration structure, the bounding volumes are hierarchically arranged into two or more levels such that each bounding volume of a first level of the hierarchy includes two or more bounding volumes of a second level of the hierarchy that is lower than the first level within the hierarchy.

When performing a ray tracing operation, the processing system first performs a ray traversal to determine whether a ray from a source within the scene intersects with a bounding volume of a first level of a hierarchy within an acceleration structure. Based on the ray not intersecting the bounding volume, the processing system ends the ray traversal and then begins a new ray traversal for a next bounding volume of the first level of the hierarchy within the acceleration structure or a bounding volume in another acceleration structure. Based on the ray intersecting the bounding volume, the processing system continues the ray traversal to determine which bounding volumes at a second level of the hierarchy included within the bounding volume intersect with the ray. In this way, the processing system recursively traverses the acceleration structure to determine which bounding volume, primitive, or both intersects with the ray.

However, storing data representing the hierarchy of bounding volumes within an acceleration structure requires a substantial memory footprint for the acceleration structure. Additionally, traversing such an acceleration structure requires significant processing resources and processing time, increasing the time and resources needed to render a scene. To this end, systems and techniques disclosed herein are directed to ray traversals of displaced micro-meshes (DMMs) using prism volumes. For example, to perform ray traversals of DMMs, a processing system includes an accelerator unit (AU) configured to first receive a coarse mesh including one or more triangular primitives (also referred to herein as “triangles”). With the coarse mesh, the AU also receives one or more mesh parameters such as displacement vectors, biases, scales, displacement values, and the like. From the coarse mesh, the AU identifies one or more base triangles to be subdivided and then recursively subdivides each of the base triangles into a predetermined number of sub-triangles arranged in a hierarchy. For example, the AU first divides a base triangle into a predetermined number of sub-triangles such that a hierarchy is established having a first level with the base triangle and a second level including the predetermined number of sub-triangles divided from the base triangle. The AU then divides each sub-triangle of the second level of the hierarchy into the predetermined number of further sub-triangles to establish a third level of the hierarchy that includes the sub-triangles subdivided from the sub-triangles of the second level of the hierarchy. Further, the AU establishes the third level of the hierarchy such that each sub-triangle of the second level of the hierarchy includes the predetermined number of respective sub-triangles of the third level. The AU then continues to establish levels of the hierarchy in this way until a predetermined number of levels is reached.

After recursively dividing a base triangle, the AU displaces the vertices of each sub-triangle divided from the base triangle based on the displacement vectors, biases, scales, and displacement values indicated in the received mesh parameters. Once the vertices of the sub-triangles have been displaced, the AU produces a DMM and stores the DMM for ray tracing operations. To perform a ray tracing operating using the DMM, the AU is configured to generate a prism volume for a current triangle of the DMM and then determine whether a ray intersects the generated prism volume. As an example, to perform a ray tracing operating using the DMM, the AU first begins with the base triangle of the DMM that includes all the sub-triangles represented by a DMM (e.g., the base triangle at the first level of the hierarchy represented by the sub-triangles of the DMM). For the base triangle, the AU generates an initial bounding volume that bounds the base triangle. For example, based on the displacement vectors, biases, and scales used to generate the DMM, the AU determines a first cap (e.g., face) of the initial bounding volume based on the minimum displacements indicated by the displacement vectors, biases, and scales indicated in the mesh parameters and a second cap of the initial bounding volume based on the maximum displacements indicated by the displacement vectors, biases, and scales of the mesh parameters. Using the first and second caps and displacement vectors used to generate the DMM, the AU then determines walls for the initial bounding volume such that the initial bounding volume bounds the base triangle of the DMM. These walls, for example, represent the side faces of the initial bounding volume as defined by the first and second caps. However, when different degrees and directions of displacement are applied to the vertices of the base triangle, the likelihood that the walls of the initial bounding volume are non-planar is increased. That is to say, the likelihood that one or more walls of the initial bounding volume include one or more curves, twists, or both is increased. As an example, due to different degrees and directions of displacement applied to the vertices of the base triangle, the likelihood that the walls of the initial bounding volume include a bilinear patch is increased.

To help compensate for the non-planarity of the walls of the initial bounding volume, the AU is configured to bound each wall of the initial bounding volume with respective bounding volumes. As an example, the AU bounds each wall of the initial bounding volume with a respective tetrahedron. The AU then combines the volumes bounding the walls of the initial bounding volume with the first and second caps of the initial bounding volume to form a prism volume. Such a prism volume, for example, represents a volume having planar faces that bounds the base triangle of the DMM. The AU then determines whether a ray intersects the generated prism volume. Based on the ray not intersecting the prism volume, the AU ends the ray traversal and begins a new ray traversal using a triangle from another DMM. Based on the ray intersecting the prism volume, the AU begins a fine ray tracing operation. During the fine ray tracing operation, the AU traverses the hierarchy indicated by the sub-triangles of the DMM to determine which sub-triangle at a predetermined level of the hierarchy first intersects with the ray. For example, the AU tests one or more sub-triangles of a second level of the hierarchy by generating prism volumes that bound the sub-triangles and determining whether the ray intersects the generated prism volumes. Based on the ray intersecting a prism volume bounding a sub-triangle of the second level, the AU then moves to a third level of the hierarchy to determine which of the sub-triangles divided from the sub-triangle of the second level intersect with the ray. For example, the AU generates prism volumes for these sub-triangles of the third level and then determines if the ray intersects the generated prism volumes. The AU then continues in this manner until a predetermined level of the hierarchy is reached.

In this way, the AU is configured to traverse a hierarchy indicated by a DMM by generating prism volumes for each triangle or sub-triangle of the DMM only when the triangle or sub-triangle is to be tested. Because the AU is configured to generate prism volumes to traverse the DMM as needed, the processing system only needs to store the DMM rather than an acceleration structure representing a bounding volume hierarchy. In this way, the memory footprint needed for the AU to perform a ray tracing operation is reduced, helping to decrease the resources and processing time needed to perform the ray tracing operation and render primitives for the scene.

As used herein, the term “circuitry” includes hardwired circuitry, programmable circuitry, or a combination thereof. For example, circuitry may include circuitry of an application-specific integrated circuit (ASIC) that is hardwired or hardcoded to perform corresponding functions, one or more processors that execute software stored in one or more memories or other storage media to perform corresponding functions, programmable logic that has been programmed to perform corresponding functions, or some combination thereof.

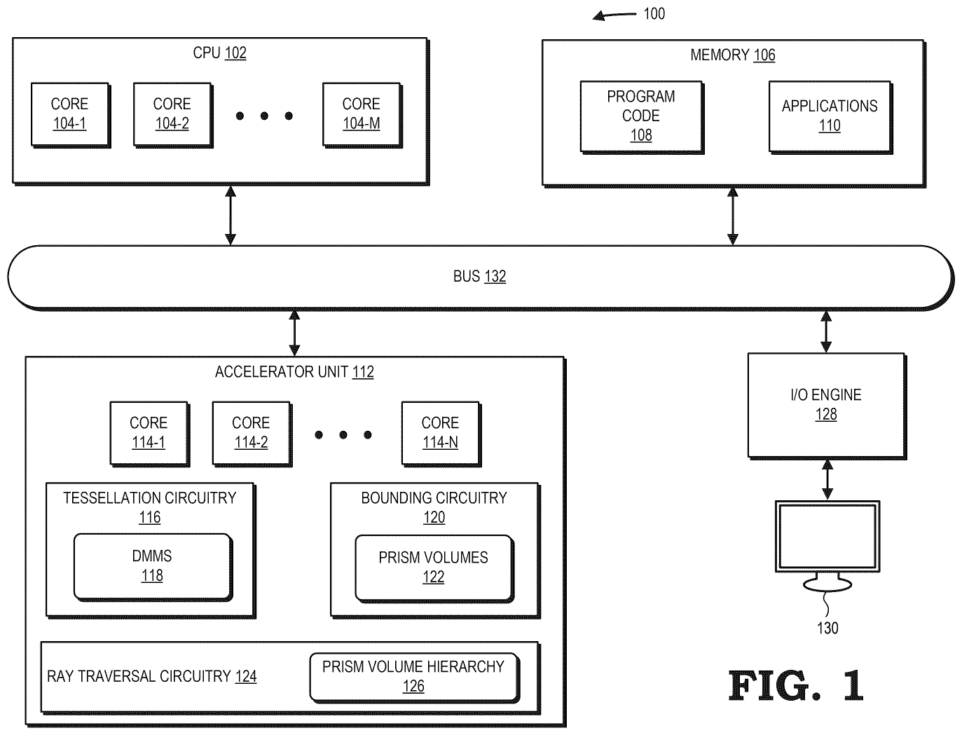

FIG. 1 illustrates a processing system 100 configured for ray tracing using a prism volume hierarchy indicated by a DMM, in accordance with some embodiments. Processing system 100 includes or has access to a memory 106 or other storage component implemented using a non-transitory computer-readable medium, for example, a dynamic random-access memory (DRAM). However, in implementations, the memory 106 is implemented using other types of memory including, for example, static random-access memory (SRAM), nonvolatile RAM, and the like. According to implementations, the memory 106 includes an external memory implemented external to the processing units implemented in the processing system 100. The processing system 100 also includes a bus 132 to support communication between entities implemented in the processing system 100, such as the memory 106. Some implementations of the processing system 100 include other buses, bridges, switches, routers, and the like, which are not shown in FIG. 1 in the interest of clarity.

The techniques described herein are, in different implementations, employed at accelerator unit (AU) 112. AU 112 includes, for example, vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (simple programmable logic devices, complex programmable logic devices, field programmable gate arrays (FPGAs)), or any combination thereof. AU 112 is configured to render a set of rendered frames each representing respective scenes within a screen space (e.g., the space in which a scene is displayed) according to one or more applications 110 for presentation on a display 130. As an example, AU 112 renders graphics objects (e.g., sets of primitives) for a scene to be displayed so as to produce pixel values representing a rendered frame. AU 112 then provides the rendered frame (e.g., pixel values) to display 130. These pixel values, for example, include color values (YUV color values, RGB color values), depth values (z-values), or both. After receiving the rendered frame, display 130 uses the pixel values of the rendered frame to display the scene including the rendered graphics objects. To render the graphics objects, AU 112 implements processor cores 114-1 to 114-N that execute instructions concurrently or in parallel. For example, AU 112 executes instructions, operations, or both from a graphics pipeline using processor cores 114 to render one or more graphics objects. A graphics pipeline includes, for example, one or more steps, stages, or instructions to be performed by AU 112 in order to render one or more graphics objects for a scene. As an example, a graphics pipeline includes a ray tracing pipeline that includes one or more stages (e.g., ray generation, ray traversal) to be performed by one or more processor cores 114 of AU 112 in order to render one or more graphics objects for a scene to be displayed.

In embodiments, one or more processor cores 114 of AU 112 each operate as a compute unit configured to perform one or more operations for one or more instructions received by AU 112. These compute units each include one or more single instruction, multiple data (SIMD) units that perform the same operation on different data sets to produce one or more results. For example, AU 112 includes one or more processor cores 114 each functioning as a compute unit that includes one or more SIMD units to perform operations for one or more instructions from a graphics pipeline. To facilitate the performance of operations by the compute units, AU 112 includes one or more command processors (not shown for clarity). Such command processors, for example, include circuitry configured to execute one or more instructions from a graphics pipeline by providing data indicating one or more operations, operands, instructions, variables, register files, or any combination thereof to one or more compute units necessary for, helpful for, or aiding in the performance of one or more operations for the instructions. Though the example implementation illustrated in FIG. 1 presents AU 112 as having three processor cores (114-1, 114-2, 114-N) representing an N number of cores, the number of processor cores 114 implemented in AU 112 is a matter of design choice. As such, in other implementations, AU 112 can include any number of processor cores 114. Some implementations of AU 112 are used for general-purpose computing. For example, in embodiments, AU 112 is configured to receive one or more instructions, such as program code 108, from one or more applications 110 that indicate operations associated with one or more video tasks, physical simulation tasks, computational tasks, fluid dynamics tasks, or any combination thereof, to name a few. In response to receiving program code 108, AU 112 executes the instructions for the video tasks, physical simulation tasks, computational tasks, and fluid dynamics tasks. AU 112 then stores information in memory 106 such as the results of the executed instructions.

In embodiments, to help render primitives for a scene, AU 112 is configured to perform one or more ray tracing operations. For example, AU 112 is configured to determine whether one or more primitives within a scene to be rendered intersect with one or more rays from one or more sources (e.g., light sources) within the scene. According to embodiments, AU 112 is configured to perform ray traversals of one or more DMMs 118. To this end, in embodiments, AU 112 is configured to first generate a mesh of primitives to be rendered in a scene based on instructions from one or more applications 110. As an example, based on instructions from an application 110, AU 112 generates a coarse mesh of triangular primitives (i.e., triangles) to be rendered. Further, based on instructions from an application 110, AU 112 generates one or more mesh parameters associated with the generated mesh. Such mesh parameters, for example, include displacement vectors, scales, biases, displacement values, or any combination thereof to be applied to one or more triangles of the mesh.

After generating the mesh and mesh parameters, AU 112 provides the mesh and mesh parameters to tessellation circuitry 116 included in or otherwise connected to AU 112. In embodiments, tessellation circuitry 116 is configured to generate one or more DMMs 118 based on the mesh (e.g., coarse mesh) and mesh parameters determined by AU 112. As an example, according to embodiments, tessellation circuitry 116 is configured to first identify one or more base triangles of the coarse mesh to be subdivided. For example, tessellation circuitry 116 identifies each triangle of the coarse mesh as a base triangle to be subdivided. Tessellation circuitry 116 then recursively subdivides each identified base triangle into predetermined numbers of respective sub-triangles arranged in a hierarchy including two or more levels. For example, tessellation circuitry 116 first subdivides a base triangle identified from a coarse mesh into a predetermined number (e.g., 4) of sub-triangles to form a hierarchy that has a first level including the base triangle and a second level including the predetermined number of (e.g., 4) sub-triangles. Tessellation circuitry 116 then further sub-divides each sub-triangle of the second level of the hierarchy into the predetermined number of respective sub-triangles such that the hierarchy has a third level including the sub-triangles resulting from the subdivision of the sub-triangles in the second level of the hierarchy. Furthermore, tessellation circuitry 116 then sub-divides each sub-triangle of the second level of the hierarchy such that each sub-triangle of the second level of the hierarchy includes the predetermined number of respective sub-triangles of the third level of the hierarchy. In this way, tessellation circuitry 116 is configured to recursively subdivide a base triangle identified from a coarse mesh to form a hierarchy of sub-triangles having any number of levels. For example, tessellation circuitry 116 is configured to recursively subdivide a base triangle in order to achieve a hierarchy of sub-triangles having a predetermined number of levels.

After recursively subdividing the base triangle, tessellation circuitry 116 is configured to displace the vertices of the sub-triangles divided from the base triangle to generate a DMM 118. For example, based on the generated mesh parameters (e.g., displacement vectors, biases, scales, displacement values) tessellation circuitry 116 is configured to apply a respective displacement to each vertex of the sub-triangles to form a DMM 118. According to embodiments, tessellation circuitry 116 determines the direction and amount of displacement to apply to a vertex of a sub-triangle based on one or more displacement vectors. As an example, in embodiments, the mesh parameters determined by AU 112 include one or more respective displacement vectors to apply to corresponding vertices of a base triangle identified from the coarse mesh. These displacement vectors, for example, each include data indicating a direction of displacement for a corresponding vertex of a base triangle. AU 112 then interpolates (e.g., linearly interpolates) these displacement vectors based on the positions of the vertices of the base triangle and the positions of the vertices of the sub-triangles divided from the base triangle to determine respective displacement sub-vectors for each vertex of the sub-triangles. Such displacement sub-vectors, for example, each include data indicating a direction of displacement for a corresponding vertex of the sub-triangles. Tessellation circuitry 116 then displaces each vertex of the base triangle and sub-triangles by a distance indicated in a respective displacement value included in the mesh parameters and in a direction indicated by a corresponding displacement vector or displacement sub-vector. In embodiments, tessellation circuitry 116 is configured to displace one or more vertices of the sub-triangles by different magnitudes (e.g., distances), directions, or both from one or more other vertices of the sub-triangles. After displacing the vertices of the base triangle and sub-triangles, tessellation circuitry 116 generates a DMM 118.

Once tessellation circuitry 116 has generated one or more DMMs 118, AU 112 is configured to perform one or more ray traversals of a DMM 118 using the hierarchy of the sub-triangles indicated by a DMM 118. For example, to perform a ray traversal of a DMM 118, bounding circuitry 120, included in or otherwise connected to AU 112, is configured to generate a respective prism volume 122 for the base triangle or one or more sub-triangles of a DMM 118 to be traversed by ray traversal circuitry 124, included in or otherwise coupled to AU 112. Such a prism volume 122, for example, includes a prism-shaped (e.g., triangular prism-shaped) volume having planar faces that bound the base triangle or a sub-triangle of the DMM 118. To begin a ray traversal of a DMM 118, in embodiments, bounding circuitry 120 is configured to generate a prism volume 122 for the base triangle or a sub-triangle of the DMM 118. To generate a prism volume 122 for a base triangle or a sub-triangle, bounding circuitry 120 is configured to first the determine minimum displacement and maximum displacement of the base triangle or sub-triangle (e.g., the maximum and minimum values of the vertices of the sub-triangles included in the base triangle or sub-triangle). Based on the determined minimum displacement, bounding circuitry 120 determines a first shape (e.g., triangular shape) representing the determined minimum displacement and forming a first (e.g., bottom) cap (e.g., face) of an initial bounding volume. Based on the determined maximum displacement, bounding circuitry 120 determines a second shape (e.g., triangular shape) representing the determined maximum displacement and forming a second (e.g., top) cap of the initial bounding volume.

After determining the first and second caps of the initial bounding volume, bounding circuitry 120 then determines the walls (e.g., side faces) of the initial bounding volume based on the first and second caps of the initial bounding volume and one or more displacement vectors or displacement sub-vectors used to displace the vertices of the base triangle or sub-triangle. After determining these walls, bounding circuitry 120 produces an initial bounding volume that bounds the base triangle or sub-triangle. However, when the respective displacement applied to each of the vertices of the base triangle or sub-triangle differs in direction, the walls of the initial bounding volume are non-planar. That is to say, the walls of the initial bounding volume include one or more twists, curves, or both. As an example, in some embodiments, based on the displacement applied to the vertices of the base triangle or sub-triangle, the walls of the initial bounding volume form one or more bilinear patches. To help compensate for the non-planarity of the walls of the initial bounding volume, bounding circuitry 120 is configured to bound each wall of the initial bounding volume with a respective bounding volume (e.g., a tetrahedron). After bounding each wall of the initial bounding volume in a respective bounding volume, bounding circuitry 120 combines the bounding volumes bounding the walls of the initial bounding volume with the first and second caps of the initial bounding volume to form a prism volume 122 bounding the base triangle or sub-triangle. As an example, bounding circuitry 120 combines respective tetrahedrons bounding the walls of the initial bounding volume with the top and bottom caps of the initial bounding volume to form a prism volume 122 that includes a number (e.g., 14) of intersecting triangles that bound the base triangle or sub-triangle.

Once bounding circuitry 120 generates the prism volume 122 for the base triangle or sub-triangle of the DMM 118, ray traversal circuitry 124 performs a ray traversal operation using the prism volume 122. For example, ray traversal circuitry 124 determines whether one or more rays from one or more sources intersect with the prism volume 122. Based on a ray not intersecting the prism volume 122, AU 112 begins the ray traversal of another triangle of the same DMM 118 or a different DMM 118. For example, AU 112 generates a second prism volume 122 for a second DMM 118 and determines whether a ray intersects the second prism volume 122. As another example, AU 112 generates a second prism volume 122 for a second sub-triangle of the DMM 118 at the same level of hierarchy as the first sub-triangle associated with the prism volume 122 that did not intersect the ray. Based on a ray intersecting the prism volume 122, ray traversal circuitry 124 performs a fine ray traversal operation.

During the fine ray traversal operation, ray traversal circuitry 124 traverses the hierarchy indicated by the DMM 118 to determine which sub-triangle of the DMM 118 at a predetermined level of the hierarchy intersects the ray. As an example, in response to the ray intersecting a prism volume 122 bounding a base triangle of the DMM 118 (e.g., the base triangle at the first level of the hierarchy), bounding circuitry 120 generates a prism volume 122 for a first sub-triangle of the second level of the hierarchy indicated by the DMM 118. Ray traversal circuitry 124 determines if the ray intersects the prism volume 122 bounding the first sub-triangle of the second level. Based on the ray not intersecting the prism volume 122 bounding the first sub-triangle of the second level, bounding circuitry 120 generates a prism volume 122 bounding a second sub-triangle of the second level and ray traversal circuitry 124 determines whether the ray intersects the prism volume 122 bounding the second sub-triangle of the second level. Bounding circuitry 120 and ray traversal circuitry 124 continue in this way until ray traversal circuitry determines the ray intersects a prism volume 122 bounding a sub-triangle of the second level. Based on the ray intersecting a prism volume 122 bounding a sub-triangle of the second level, ray tracing circuitry 124 then determines which sub-triangle of the third level divided from the sub-triangle of the second level intersects the ray with bounding circuitry 120 generating prism volumes 122 bounding the sub-triangles as the sub-triangles are to be tested. According to embodiments, bounding circuitry 120 and ray traversal circuitry 124 continue traversing prism volumes 122 in this way until a predetermined level of the hierarchy represented by the DMM 118 is reached.

In this way, AU 112 is configured to perform a ray traversal of a prism volume hierarchy 126 indicated by the DMM 118. That is to say, bounding circuitry 120 is configured to generate prism volumes 122 as needed as ray traversal circuitry 124 traverses the sub-triangle hierarchy indicated by a DMM 118. Because bounding circuitry 120 only generates prism volumes 122 as needed during a ray traversal rather than generating an acceleration structure storing hierarchical bounding volumes representing an entire scene to be rendered, the memory footprint needed for AU 112 to perform a ray tracing operation is reduced. Due to the memory footprint of the ray tracing operation being reduced, the resources and processing time needed to perform the ray tracing operation are decreased, helping to improve processing efficiency for processing system 100.

In some embodiments, processing system 100 includes input/output (I/O) engine 128 that includes circuitry to handle input or output operations associated with display 130, as well as other elements of the processing system 100 such as keyboards, mice, printers, external disks, and the like. The I/O engine 128 is coupled to the bus 132 so that the I/O engine 128 communicates with the memory 106, AU 112, or the central processing unit (CPU) 102.

According to embodiments, processing system 100 also includes CPU 102 that is connected to the bus 132 and therefore communicates with AU 112 and the memory 106 via the bus 132. CPU 102 implements a plurality of processor cores 104-1 to 104-M that execute instructions concurrently or in parallel. In implementations, one or more of the processor cores 104 operate as SIMD units that perform the same operation on different data sets. Though in the example implementation illustrated in FIG. 1, three processor cores (104-1, 104-2, 104-M) are presented representing an M number of cores, the number of processor cores 104 implemented in CPU 102 is a matter of design choice. As such, in other implementations, CPU 102 can include any number of processor cores 104. In some implementations, CPU 102 and AU 112 have an equal number of processor cores 104, 114 while in other implementations, CPU 102 and AU 112 have a different number of processor cores 104, 114. The processor cores 104 of CPU 102 are configured execute instructions such as program code 108 for one or more applications 110 (e.g., graphics applications, compute applications, machine-learning applications) stored in the memory 106, and CPU 102 stores information in the memory 106 such as the results of the executed instructions. CPU 102 is also able to initiate graphics processing by issuing draw calls to AU 112.

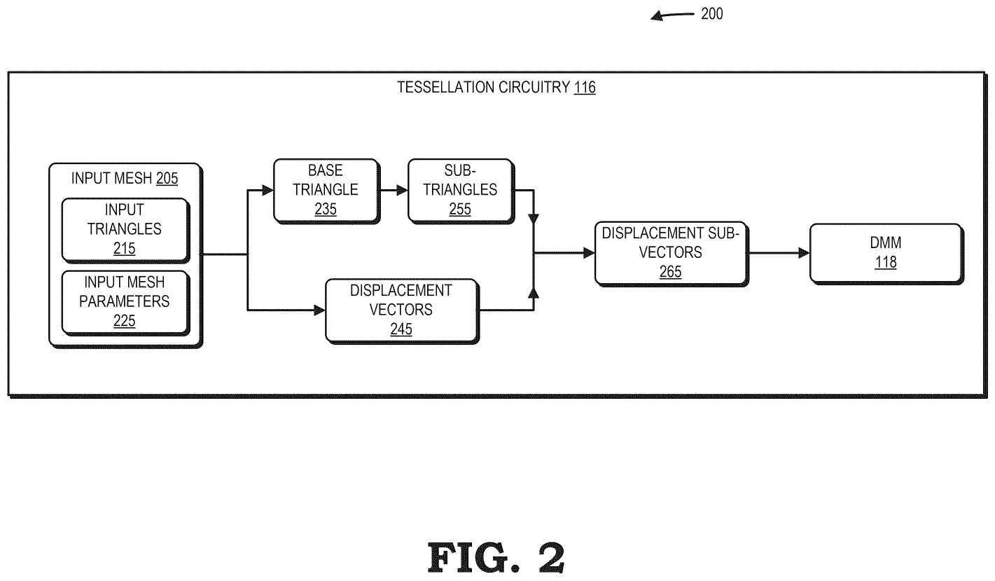

Referring now to FIG. 2, an example operation 200 to generate a DMM 118 is presented, in accordance with some embodiments. In embodiments, example operation 200 is implemented by tessellation circuitry 116 of AU 112 within processing system 100 to generate one or more DMMs 118. According to embodiments, example operation 200 first includes AU 112 generating input mesh 205 based on one or more instructions from an application 110. Input mesh 205, for example, includes data indicating one or more contiguous triangular primitives (represented in FIG. 2 as input triangles 215) to be rendered for a scene. Additionally, input mesh 205 includes one or more input mesh parameters 225. These input mesh parameters 225, for example, include data (e.g., a displacement map) indicating one or more displacement vectors 245, scales, biases, displacement values, or any combination thereof to be applied to the input triangles 215. As an example, in embodiments, input mesh parameters 225 include respective displacement vectors 245 to be applied to each vertex of a corresponding base triangle 235 identified from input mesh 205. As another example, input mesh parameters 225 include respective scales, biases, or both to apply to each displacement vector 245. As yet another example, input mesh parameters 225 include respective displacement values each indicating how far to displace a corresponding vertex of a base triangle 235 or a sub-triangle 255 divided from a respective base triangle 235.

After AU 112 generates input mesh 205, AU 112 provides input mesh 205 to tessellation circuitry 116. Based on input triangles 215 indicated in the received input mesh 205, tessellation circuitry 116 identifies one or more base triangles 235 to be recursively subdivided. As an example, tessellation circuitry 116 identifies each input triangle 215 of the input mesh 205 as a base triangle 235 to be recursively subdivided. After tessellation circuitry 116 identifies one or more base triangles 235 from input mesh 205, tessellation circuitry 116 recursively subdivides each base triangle 235 into a predetermined total number of sub-triangles 255 arranged in a hierarchy having a predetermined number of levels. As an example, tessellation circuitry 116 first sub-divides a base triangle 235 into a predetermined number of sub-triangles 255 (e.g., 4 sub-triangles) arranged in a hierarchy having a first level that includes the base triangle 235 and a second level that includes the sub-triangles 255. Tessellation circuitry 116 then subdivides each sub-triangle 255 into the predetermined number of further sub-triangles 255 arranged such that a third level of the hierarchy includes the sub-triangles 255 divided from the sub-triangles 255 of the second level and such that each sub-triangle 255 of the second level includes the predetermined number of respective sub-triangles 255 of the third level.

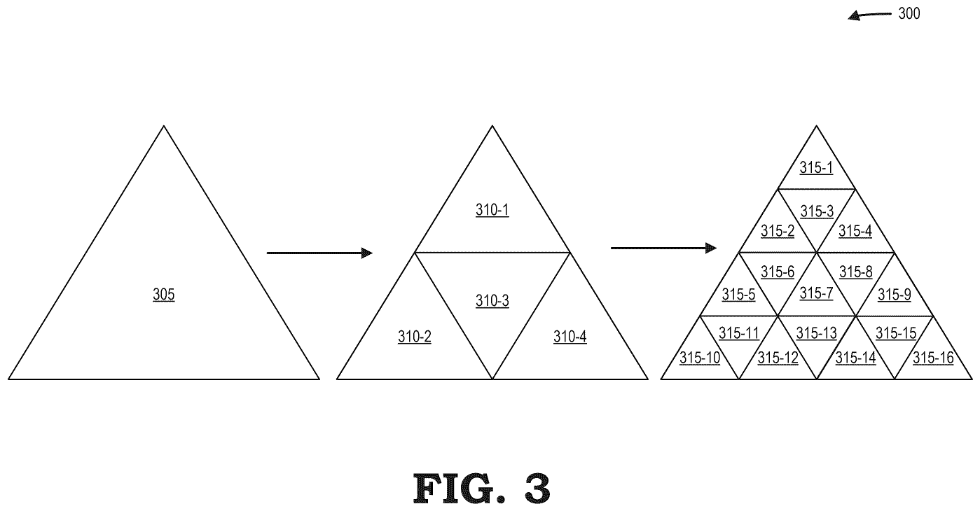

As an example, referring now to FIG. 3, an example operation 300 for recursively subdividing a base triangle 305 (e.g., base triangle 235) is presented. In embodiments, example operation 300 is implemented by tessellation circuitry 116 of AU 112 within processing system 100. According to embodiments, example operation 300 first includes tessellation circuitry 116 subdividing a base triangle 305 into a predetermined number of sub-triangles 310. As an example, tessellation circuitry 116 subdivides base triangle 305 into four sub-triangles 310-1, 310-2, 310-3, 310-4. Further, by tessellation circuitry 116 subdividing base triangle 305 into four sub-triangles 310, base triangle 305 and sub-triangles 310 are arranged in a hierarchy having a first level that includes base triangle 305 and a second level that includes sub-triangles 310 each included in base triangle 305. Further, example operation 300 includes subdividing each sub-triangle 310 into the predetermined number of respective sub-triangles 315. For example, tessellation circuitry 116 subdivides sub-triangle 310-1 into four respective sub-triangles 315-1, 315-2, 315-3, and 315-4; sub-triangle 310-2 into four respective sub-triangles 315-5, 315-10, 315-11, and 315-12; sub-triangle 310-3 into four respective sub-triangles 315-6, 315-7, 315-8, and 315-13; and sub-triangle 310-4 into four respective sub-triangles 315-9, 315-14, 315-15, and 315-16. Further, by tessellation circuitry 116 subdividing each sub-triangle 310 of base triangle 305 into four respective sub-triangles 315, base triangle 305, sub-triangles 310, and sub-triangles 315 are arranged in a hierarchy having a first level that includes base triangle 305, a second level that includes sub-triangles 310, and a third level including sub-triangles 315. Further, within the hierarchy, base triangle 305 includes all the sub-triangles 310, 315 and each sub-triangle 310 includes four respective sub-triangles 315 (e.g., the respective sub-triangles 315 divided from the sub-triangle 310). In embodiments, example operation 300 includes tessellation circuitry 116 further recursively sub-dividing sub-triangles 315 so as to form a hierarchy including any number of levels. For example, example operation 300 includes tessellation circuitry recursively sub-dividing sub-triangles 315 so as to form a hierarchy including a predetermined number of levels defined by the program code 108 of one or more applications 110.

Referring again to FIG. 2, after recursively subdividing the base triangle 235, example operation 200 includes tessellation circuitry 116 displacing the vertices of the sub-triangles 255 divided from a base triangle 235 based on input mesh parameters 225. For example, in some embodiments, tessellation circuitry 116 first determines respective directions and distances to displace each vertex of the base triangle 235 based on corresponding displacement vectors 245 indicated in input mesh parameters 225. Such displacement vectors 245, for example, include a magnitude, direction, or both in which to displace a respective vertex of a base triangle 235. As another example, in embodiments, tessellation circuitry 116 applies a respective bias, scale, or both to each displacement vector 245 and then displaces each vertex of the base triangle 235 by an amount based on a respective displacement vector 245 as modified by a corresponding bias, scale, or both.

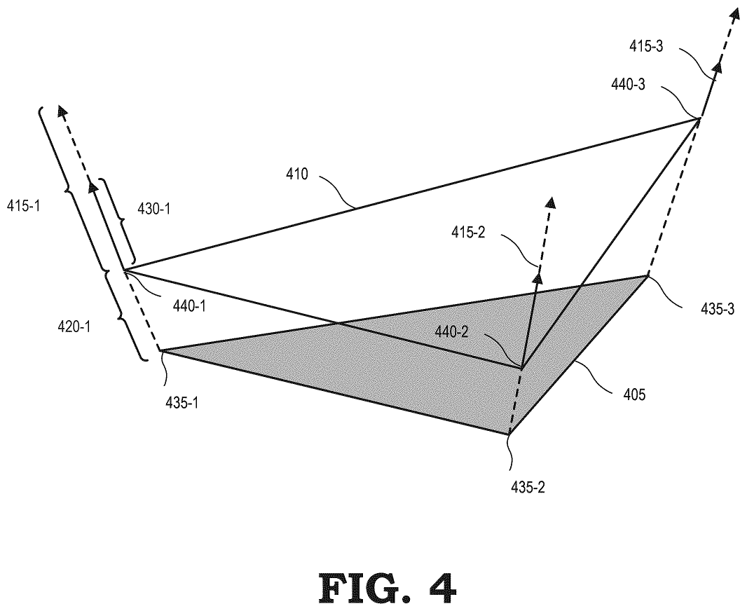

As an example, referring now to FIG. 4, an example base triangle 405 with displaced vertices is presented, in accordance with some embodiments. As represented by FIG. 4, example base triangle 405 (e.g., base triangle 235) includes a first vertex 435-1, a second vertex 435-2, and a third vertex 435-3. Based on respective biases indicated in input mesh parameters 225, tessellation circuitry 116 displaces each vertex 435 of base triangle 405 by an amount indicated by the corresponding bias to produce biased triangle 410 having vertices 440-1, 440-2, and 440-3. For example, tessellation circuitry 116 displaces the first vertex 435-1 of the example base triangle 405 by an amount indicated by a bias 420-1 to form vertex 440-1. After the vertices of the example base triangle 405 are biased to form biased triangle 410, tessellation circuitry 116 applies a respective scale, indicated by the input mesh parameters 225, to each displacement vector 245 to be applied to a vertex 430 of the biased triangle 410 to produce modified displacement vectors. As an example, tessellation circuitry 116 applies scale 430-1 to a displacement vector 245 to be applied to vertex 435-1 to produce modified displacement vector 415-1. Once tessellation circuitry 116 determines the modified displacement vectors 415-1, 415-2, 415-3, tessellation circuitry 116 displaces each vertex 440 of the biased triangle 410 by a distance and direction based on a corresponding modified displacement vector 415-1, 415-2, 415-3.

Referring again to FIG. 2, after displacing the vertices of the base triangle 235, tessellation circuitry 116 interpolates (e.g., linearly interpolates) a respective displacement sub-vector 255 for each vertex of each sub-triangle 255 of the base triangle 235 using the displacement vectors 245 applied to the base triangle 235. For example, tessellation circuitry 116 interpolates a respective displacement sub-vector 255 from the displacement vectors 245 applied to an associated base triangle 235 based on the position of a corresponding vertex of a sub-triangle and the positions of the vertices of the associated base triangle 235. Each displacement sub-vector 265, for example, indicates a direction in which to displace a vertex of a sub-triangle 255. After determining the displacement sub-vectors 265 for the vertices of each sub-triangle 255 divided from the base triangle 235, tessellation circuitry 116 displaces each vertex of the sub-triangles 255 in a direction indicated by a corresponding displacement sub-vector 265 and by a distance indicated by input mesh parameters 225. As an example, tessellation circuitry 116 displaces each vertex of the sub-triangles by a respective distance indicated by a corresponding displacement value indicated in input mesh parameters 225. Once tessellation circuitry 116 displaces the vertices of the sub-triangles 255, tessellation circuitry produces a respective DMM 118. According to embodiments, tessellation circuitry 116 then stores the DMM 118 in memory 106 for use in one or more ray tracing operations.

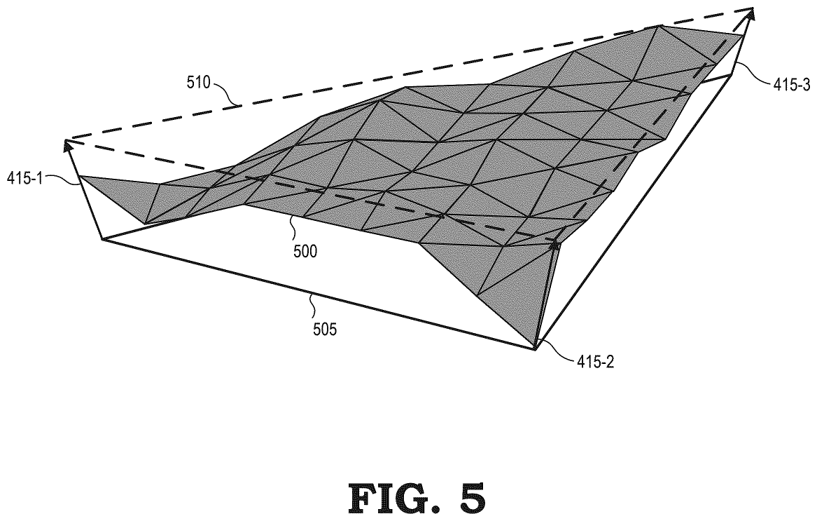

Referring now to FIG. 5, an example DMM 500 is presented. In embodiments, example DMM 500, similar to or the same as a DMM 118, is generated according to example operation 200 implemented by processing system 100. According to embodiments, example DMM 500 is bounded by a minimum displacement 505 and a maximum displacement 510. Minimum displacement 505, for example, represents the position of the vertices of one or more triangles (e.g., base triangle, sub-triangles) of example DMM 500 that have the lowest position after being displaced. In the example embodiment presented in FIG. 5, minimum displacement 505 is represented as a triangular plane that is parallel to at least a portion of example DMM 500 and that intersects the vertices of one or more triangles (e.g., base triangle, sub-triangles) having the lowest position after being displaced. Maximum displacement 510, as an example, represents the position of the vertices of one or more triangles (e.g., base triangle, sub-triangles) of example DMM 500 that have the highest position after being displaced. According to the example embodiment presented in FIG. 5, maximum displacement 510 is represented as a triangular plane that is parallel to at least a portion of example DMM 500 and that intersects the vertices of one or more triangles (e.g., base triangle, sub-triangles) having the highest position after being displaced. According to embodiments, tessellation circuitry 116 is configured to determine minimum displacement 505 and maximum displacement 510 based on the modified displacement vectors 415 applied to a base triangle (e.g., base triangle 405). As an example, based on the modified displacement vectors 415, tessellation circuitry 116 determines a first triangular plane representing minimum displacement 505 and a second triangular plane representing maximum displacement 510 such that the first and second triangular planes bound example DMM 500.

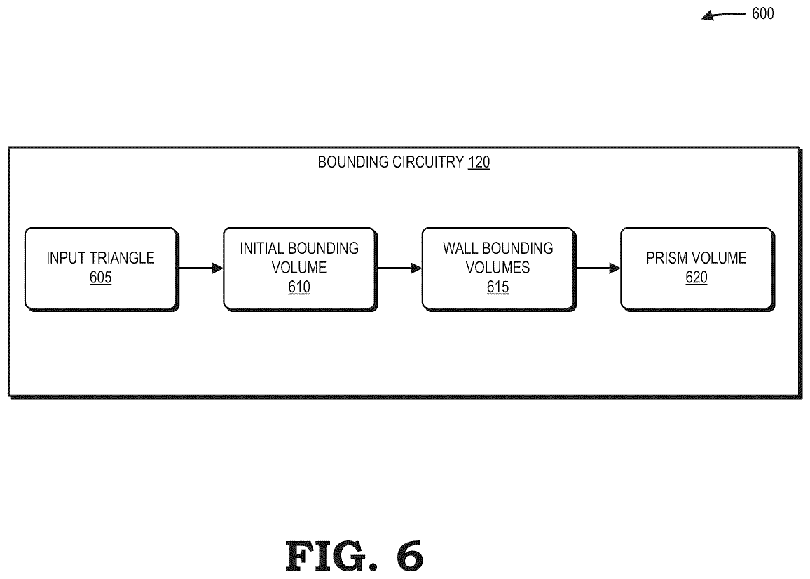

Referring now to FIG. 6, an example operation 600 for generating prism volumes that bound triangles of a DMM is presented, in accordance with some embodiments. According to embodiments, example operation 600 is implemented by bounding circuitry 120 of AU 112 within processing system 100. In embodiments, example operation 600 first includes bounding circuitry 120 receiving an input triangle 605 representing, for example, a base triangle (e.g., base triangles 235, 305) or a sub-triangle (e.g., sub-triangles 255, 315) of a DMM 118. As an example, bounding circuitry 120 is configured to receive input triangle 605 from a stack, buffer, or both including data representing the base triangles and sub-triangles of a DMM 118. Based on the input triangle 605, bounding circuitry 120 then generates an initial bounding volume 610 bounding the input triangle 605. As an example, bounding circuitry 120 first determines a minimum displacement (e.g., minimum displacement 505) representing the position of one or more vertices of the sub-triangles 255 included in input triangle 605 having a lowest position and a maximum displacement (e.g., maximum displacement 510) representing the position of one or more vertices of the sub-triangles 255 included in input triangle 605 having a highest position. Based on the determined minimum displacement and maximum displacement, bounding circuitry 120 then determines two caps (e.g., faces) that bound opposing sides of the input triangle 605 (e.g., top and bottom sides). For example, bounding circuitry 120, based on the determined minimum displacement, generates a first plane (e.g., triangular plane) that intersects only the one or more vertices of the sub-triangles 255 included in the input triangle 605 having the lowest position and that is parallel to at least a portion of the input triangle 605. Likewise, bounding circuitry 120, based on the determined maximum displacement, generates a second plane (e.g., triangular plane) that intersects only the one or more vertices of the sub-triangles 255 included in the input triangle 605 having the highest position and that is parallel to at least a portion of the input triangle 605. Further, bounding circuitry 120 generates the first and second planes such that they form two caps that bound opposing sides (e.g., top and bottom sides) of the input triangle 605.

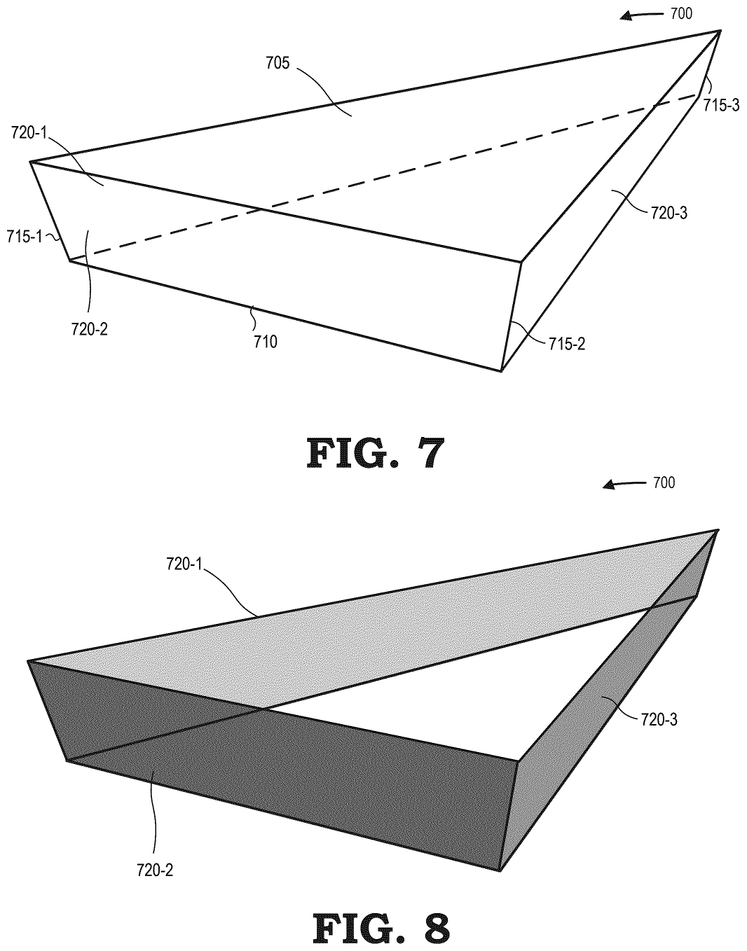

After determining the first and second caps of the initial bounding volume 610, bounding circuitry 120 then determines the walls (e.g., side faces) of the initial bounding volume 610 based on the first cap, the second cap, and the respective displacement vectors (e.g., displacement vectors 245, modified displacement vectors 415, displacement sub-vectors 265) applied to the vertices of input triangle 605. For example, FIGS. 7 and 8 together present an example initial bounding volume 700. In embodiments, example initial bounding volume 700 is similar to or the same as initial bounding volume 610. According to embodiments, example initial bounding volume 700 includes first cap 710 represented in FIG. 7 as a triangular plane. In embodiments, bounding circuitry 120 is configured to determine first cap 710 based on the minimum displacement of an input triangle 605. Further, example initial bounding volume 700 includes a second cap 705 represented in FIG. 7 as a second triangular plane. According to embodiments, bounding circuitry 120 is configured to determine second cap 705 based on the minimum displacement of an input triangle 605.

Further, still referring to FIGS. 7 and 8, example initial bounding volume 700 includes three walls 720-1, 720-2, and 720-3. Walls 720 are represented in the example embodiment presented in FIG. 8 as the shaded portions of example initial bounding volume 700. In some embodiments, bounding circuitry 120 is configured to generate each wall 720 based on the first cap 710, second cap 705, and one or more displacement vectors 715 (e.g., displacement vectors 245, modified displacement vectors 415, displacement sub-vectors 265) applied to the vertices of the input triangle 605. For example, bounding circuitry 120 is configured to determine wall 720-1 based on first cap 710, second cap 705, displacement vector 715-1 and displacement vector 715-3. As another example, bounding circuitry 120 is configured to determine wall 720-2 based on first cap 710, second cap 705, displacement vector 715-1, and displacement vector 715-2. As yet another example, bounding circuitry 120 is configured to determine wall 720-3 based on first cap 710, second cap 705, displacement vector 715-2, and displacement vector 715-3.

Referring again to FIG. 6, due to the displacement vectors of the input triangle 605 displacing the vertices of the input triangle 605 by different values, in different directions, or both, the walls (e.g., walls 720) of the initial bounding volume 610 are non-planar. For example, due to the displacement vectors of the input triangle 605 displacing the vertices of the input triangle 605 by different values, directions, or both, the walls of the initial bounding volume 610 include one or more curves, twists, or both such that the wall is non-planar. As an example, in embodiments, a wall of the initial bounding volume 610 includes one or more bilinear patches based on the displacement vectors applied to the input triangle 605. As such, in embodiments, bounding circuitry 120 is configured to generate respective bounding volumes (e.g., wall bounding volumes 615) that each bound a corresponding wall of the initial bounding volume 610. As an example, in some embodiments, bounding circuitry 120 is configured to generate wall bounding volumes 615 that each include a tetrahedron bounding the walls of the initial bounding volume 610. After generating the wall bounding volumes 615, bounding circuitry 120 combines the wall bounding volumes 615 with the first cap (e.g., first cap 710) and the second cap (e.g., second cap 705) of the initial bounding volume 610 to form a prism volume 620 (e.g., prism volume 122) that has planar faces and that bounds input triangle 605. After generating the prism volume 620, bounding circuitry 120 provides the prism volume 620 to ray traversal circuitry 124. Ray traversal circuitry 124 then performs one or more ray traversals using the prism volume 620 to determine if one or more rays intersect with the prism volume 620.

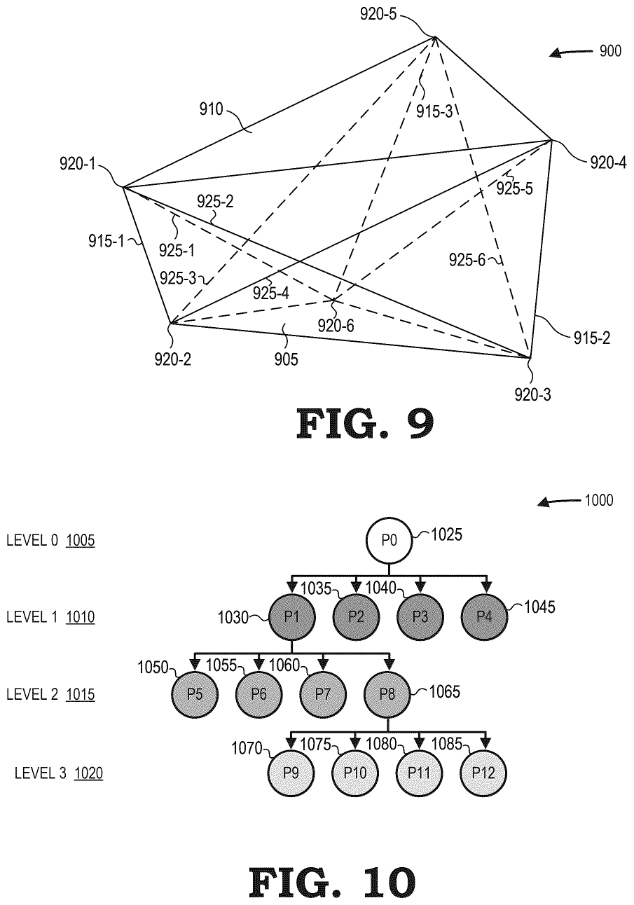

Referring now to FIG. 9, an example prism volume 900 is presented. In embodiments, example prism volume 900 is similar to or the same as prism volumes 122, 620. According to embodiments, example prism volume 900 includes six vertices 920-1, 920-2, 920-3, 920-4, 920-5, and 920-6. Further, example prism volume 900 is formed from a first cap 910 of an initial bounding volume 610 defined by vertices 920-1, 920-4, and 920-5 and a second cap 905 of the initial bounding volume 610 defined by vertices 920-2, 920-3, and 920-6. According to embodiments, example prism volume 900 also includes sides 915-1, 915-2, and 915-3 defined by three wall bounding volumes 615 each forming a tetrahedron. Within the example embodiment presented in FIG. 9, each edge of prism volume 900 (e.g., side 915), defined by vertices 920-1, 920-2, 920-3, 920-4, 920-5, and 920-6, and each line 925-1, 925-2, 925-3, 925-4, 925-5, and 925-6 form at least a portion of a respective tetrahedron of the wall bounding volumes 615. That is to say, lines 925-1, 925-2, 925-3, 925-4, 925-5, and 925-6 together with the sides 915, first cap 905, and second cap 910 represent the number of triangles (e.g., 14 triangles) that form prism volume 900.

Referring now to FIG. 10, an example hierarchy 1000 indicated by a DMM 118 is presented. According to embodiments, example hierarchy 1000 includes a prism volume hierarchy 126 indicated by a DMM 118. In embodiments, example hierarchy 1000 includes a first level (e.g., level 0 1005) that includes a prism volume 0 1025 bounding, for example, a base triangle 235 of a DMM 118. According to embodiments, example hierarchy 1000 further includes a second level (e.g., level 1 1010) that includes prism volumes 620 each bounding respective sub-triangles 255 divided from the base triangle 235 of the DMM 118. As an example, level 1 1010 includes a first prism volume 1 1030 bounding a first sub-triangle 255 divided from the base triangle 235, a second prism volume 2 1035 bounding a second sub-triangle 255 divided from the base triangle 235, a third prism volume 3 1040 bounding a third sub-triangle 255 divided from the base triangle 235, and a fourth prism volume 4 1045 bounding a fourth sub-triangle 255 divided from the base triangle 235. Further, in embodiments, example hierarchy 1000 further includes a third level (e.g., level 2 1015) that includes prism volumes 620 each bounding respective sub-triangles 255 divided from the sub-triangles included in the second level of the example hierarchy 1000. For example, level 2 1015 includes a first prism volume 5 1050 bounding a first sub-triangle 255 divided from a first sub-triangle of level 1 1010, a second prism volume 6 1055 bounding a second sub-triangle 255 divided from a first sub-triangle of level 1 1010, a third prism volume 7 1060 bounding a third sub-triangle 255 divided from a first sub-triangle of level 1 1010, and a fourth prism volume 8 1065 bounding a fourth sub-triangle 255 divided from a first sub-triangle of level 1 1010.

Also, in embodiments, example hierarchy 1000 further includes a fourth level (e.g., level 3 1020) that includes prism volumes 620 each bounding respective sub-triangles 255 divided from the sub-triangles included in the third level of the example hierarchy 1000. For example, level 3 1020 includes a first prism volume 9 1050 bounding a first sub-triangle 255 divided from a first sub-triangle of level 2 1015, a second prism volume 10 1075 bounding a second sub-triangle 255 divided from a first sub-triangle of level 2 1015, a third prism volume 11 1080 bounding a third sub-triangle 255 divided from a first sub-triangle of level 2 1015, and a fourth prism volume 12 1085 bounding a fourth sub-triangle 255 divided from a first sub-triangle of level 2 1015. According to embodiments, ray traversal circuitry 124 is configured to perform one or more ray traversals of example hierarchy 1000. For example, for level 0 1005 of the example hierarchy 1000, bounding circuitry 120 generates prism volume 0 1025 and ray traversing circuitry 124 determines whether a ray intersects prism volume 0 1025. Based on the ray intersecting prism volume 0 1025, ray traversing circuitry 124 traverses to level 1 1010 of the example hierarchy. To this end, based on the ray intersecting prism volume 0 1025, bounding circuitry 120 generates prism volume 1 1030 and ray tracing circuitry determines whether the ray intersects prism volume 1 1030. Based on the ray intersecting prism volume 1 1030, ray traversing circuitry 124 traverses to level 2 1015 of the example hierarchy, and bounding circuitry 120 generates the prism volumes 5 1050, 6 1055, 7 1060, and 8 1065 as needed for the ray traversal. In this way, bounding circuitry 120 only generates prism volumes for sub-triangles 255 of a DMM 118 currently being traversed by ray traversal circuitry 124 rather than generating an acceleration structure including all the prism volumes as indicated by example hierarchy 1000.

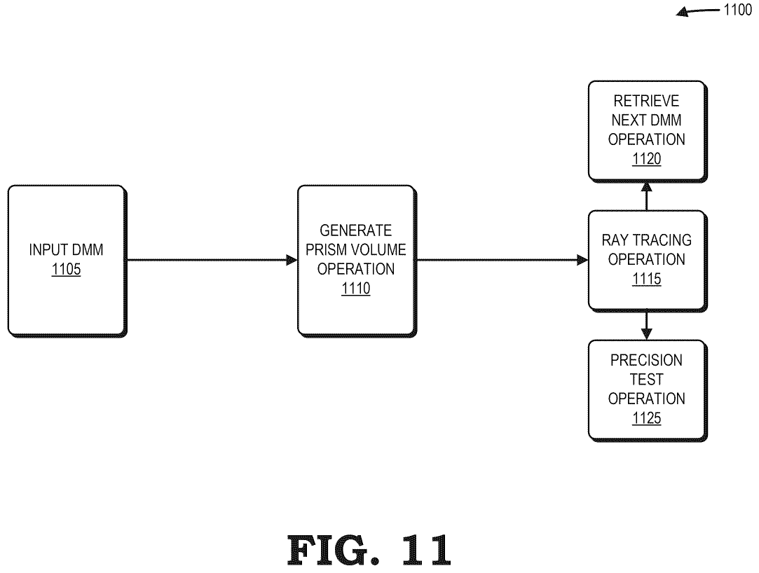

Referring now to FIG. 11, an example operation 1100 for ray tracing using a prism volume is presented, in accordance with some embodiments. In embodiments example operation 1100 is implemented by AU 112 within processing system 100. In embodiments, example operation 1100 first includes AU 112 receiving a DMM 118 to be traversed, represented in FIG. 11 as input DMM 1105. As an example, AU 112 retrieves input DMM 1105 from memory 106. After receiving input DMM 1105, AU 112 performs generate prism volume operation 1110. Generate prism volume operation 1110, for example, includes AU 112 generating a prism volume 620 for the base triangle 235 of input DMM 1105. As an example, bounding circuitry 120 implements example operation 600 to first generate an initial bounding volume 610 for the base triangle 235 of input DMM 1105. Using the initial bounding volume 610, bounding circuitry 120 then generates wall bounding volumes 615 that bound the walls of the initial bounding volume 610. After generating the wall bounding volumes 615, bounding circuitry 120 combines the wall bounding volumes with the first and second caps (e.g., top and bottom caps) of the initial bounding volume 610 to form a prism volume 620 that bounds the base triangle 235 of input DMM 1105.

After AU 112 generates the prism volume 620 for the base triangle 235 of input DMM 1105, example operation 1100 includes ray traversal circuitry 124 performing ray tracing operation 1115. During ray tracing operation 1115, ray traversal circuitry 124 determines whether a ray from a source within a scene intersects the prism volume 620 for the base triangle 235 of input DMM 1105. Based on the ray not intersecting the prism volume 620, ray traversal circuitry 124 performs retrieve next DMM operation 1120. Retrieve next DMM operation 1120, for example, includes ray traversal circuitry 124 retrieving a second DMM 118 and again performing example operation 1110 using the second DMM 118 as input DMM 1105. Based on the ray intersecting the prism volume 620, ray traversal circuitry 124 performs precision test operation 1125. During precision test operation 1125, ray traversal circuitry 124 traverses the hierarchy of prism volumes 620 indicated by input DMM 1105 to determine which prism volume 620, sub-triangle, or both of input DMM 1105 intersects the ray. For example, after determining that the ray intersects the prism volume 620 bounding the base triangle 235 of input DMM 1105, AU 112 generates one or more prism volumes 620 for the sub-triangles 255 at a second level of the hierarchy indicated by input DMM 1105. Ray traversal circuitry 124 then determines whether the ray intersects one or more of the generated prism volumes 620. Based on the ray intersecting a prism volume 620 bounding a sub-triangle in the second level of the hierarchy, AU 112 generates one or more prism volumes 620 for the sub-triangles 255 at a third level of the hierarchy that were subdivided from the sub-triangle bounded by the prism volume 620 that intersected the ray. AU 112 and ray traversal circuitry 124 then continue until a predetermined level of the hierarchy indicated by input DMM 1105 is reached.

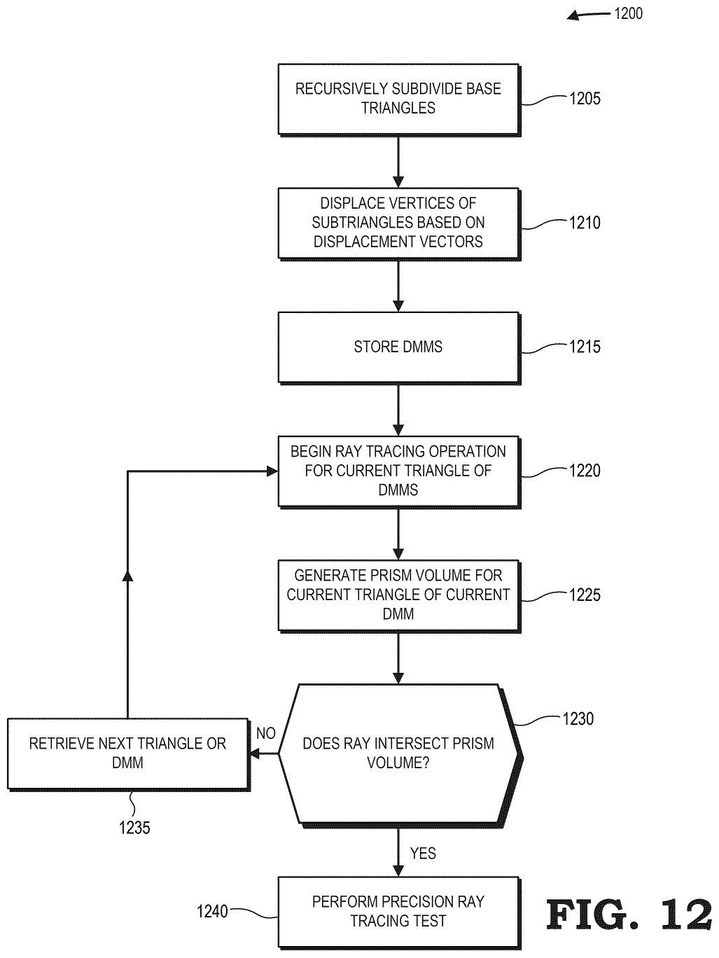

Referring now to FIG. 12, an example method 1200 for ray tracing using generated prism volumes is presented, in accordance with some embodiments. In embodiments, example method 1200 includes, at block 1205, AU 112 first generating one or more coarse meshes (e.g., input mesh 205) that include input triangles (e.g., input triangles 215) and mesh parameters (e.g., input mesh parameters 225). Such input mesh parameters, for example, include displacement vectors (e.g., displacement vectors 245) to apply to the vertices of a base triangle, scales, biases, displacement values, or any combination thereof. Such displacement values, for example, each include data indicating a corresponding distance to displace a respective vertex of a sub-triangle divided from a base triangle. After generating a coarse mesh, AU 112 then identifies one or more base triangles (e.g., base triangle 235) within the coarse mesh to subdivide. For example, AU 112 identifies each input triangle of the coarse mesh as a base triangle to subdivide. Still referring to block 1205, AU 112 then recursively subdivides one or more of the identified base triangles each into a predetermined number of sub-triangles (e.g., sub-triangles 255). As an example, AU 112 first subdivides a base triangle into a predetermined number of sub-triangles and then divides each sub-triangle further into a predetermined number of further sub-triangles. In embodiments, AU 112 is configured to recursively subdivide a base triangle into sub-triangles so as to establish a hierarchy. For example, after subdividing a base triangle into a predetermined number of sub-triangles, AU 112 establishes a hierarchy having a first level including the base triangle and a second level including the predetermined number of sub-triangles. Further, after dividing each sub-triangle of the second level of the hierarchy into the predetermined number of further sub-triangles, AU 112 establishes a third level of the hierarchy that includes the sub-triangles divided from the sub-triangles of the second level of the hierarchy. Additionally, AU 112 establishes the third level of the hierarchy such that each sub-triangle of the second level includes the predetermined number of respective sub-triangles in the third level (e.g., the sub-triangles at the third level of the hierarchy divided from the sub-triangle of the second level).

After recursively sub-dividing one or more base triangles, at block 1210, AU 112 is configured to displace the respective sub-triangles subdivided from each base triangle based on the mesh parameters. As an example, AU 112 is configured to displace the sub-triangles divided from a base triangle based on one or more displacement vectors indicated by the mesh parameters. For example, based on a respective displacement vector for each vertex of a base triangle, AU 112 determines a corresponding direction to displace each vertex of the base triangle. Additionally, based on the displacement vectors associated with each vertex of the base triangle, AU 112 determines respective displacement sub-vectors (e.g., displacement sub-vectors 265) each indicating a corresponding direction to displace a respective vertex of a sub-triangle divided from the base triangle. For example, AU 112 interpolates the displacement sub-vectors from the displacement vectors applied to the vertices of the base triangle. Once AU 112 determines the directions in which to displace the vertices of the base triangle and associated sub-triangles, AU 112 displaces each vertex of the base triangle and associated sub-triangles by a distance indicated by a displacement value included in the mesh parameters and in a direction indicated by an associated displacement vector or displacement sub-vector. After AU 112 displaces the vertices of the base triangle and associated sub-triangles, AU 112 produces a respective DMM 118. Further, for each DMM 118 generated by AU 112 based on the received coarse mesh, AU 112, at block 1215, stores the generated DMMs 118 in memory 106, a cache of AU 112, or both.

At block 1220, AU 112 retrieves a DMM 118 from, for example, memory 106, a cache of AU 112, or both. AU 112 then performs a ray traversal of the retrieved DMM 118. For example, at block 1220, AU 112 begins a ray traversal for a current triangle (e.g., base triangle, sub-triangle) of the retrieved DMM. In embodiments, to perform a ray traversal of the current triangle of the DMM 118, AU 112 is configured to determine whether a ray from a source within a scene intersects the current triangle of the DMM 118. To this end, at block 1225, AU 112 is configured to generate a prism volume 620 that bounds the current triangle of the DMM 118. As an example, AU 112 first determines a minimum displacement and a maximum displacement for the current triangle based on the displacement vectors or displacement sub-vectors applied to the vertices of the current triangle. Based on the determined minimum displacement, AU 112 first generates an initial bounding volume (e.g., initial bounding volume 610). For example, in embodiments, AU 112 generates a first cap (e.g., face) of the initial bounding volume forming a first plane (e.g., triangular plane) representing the determined minimum displacement and a second cap of the initial bounding volume forming a second plane (e.g., triangular plane) representing the determined maximum displacement. According to embodiments, AU 112 generates the first and second caps such that they bound opposing sides (e.g., top and bottom sides) of the current triangle. AU 112 then determines the walls of the initial bounding volume based on the first and second caps and the displacement vectors or displacement sub-vectors applied to the vertices of the current triangle. After determining the walls of the initial bounding volume, AU 112 then bounds each wall of the initial bounding volume in a respective wall bounding volume (e.g., wall bounding volume 615). As an example, AU 112 bounds each wall of the initial bounding volume in a respective tetrahedron. AU 112 next combines the first and second caps of the initial bounding volume with the wall bounding volumes to produce a prism volume (e.g., prism volume 620) having planar faces and bounding the current triangle.

Once the prism volume bounding the current triangle has been generated, at block 1230, AU 112 determines whether a ray from a source within a scene intersects the prism volume. Based on the ray not intersecting the prism volume bounding the current triangle, at block 1235, AU 112 retrieves a next triangle, DMM 118, or both for a next ray traversal. For example, based on a ray not intersecting a prism volume bounding a base triangle of a DMM 118, AU 112 retrieves another DMM 118 for a next ray traversal. As another example, based on a ray not intersecting a prism volume bounding a first sub-triangle of a second level of a hierarchy associated with a DMM 118, AU 112 retrieves a second sub-triangle from the second level of the hierarchy associated with the DMM 118. After retrieving the next triangle, DMM 118, or both, at block 1220, AU 112 performs another ray traversal using the retrieved triangle or a triangle from a retrieved DMM 118 as the current triangle. Referring again to block 1230, based on the ray intersecting the prism volume bounding the current triangle, AU 112 performs a precision ray tracing test at block 1240. During the precision ray tracing test, AU 112 traverses the hierarchy indicated by the DMM 118 to indicate which sub-triangle of a predetermined level of the hierarchy first intersects the ray. During the precision ray tracing test, AU 112 generates prism volumes for the sub-triangles when they are to be tested. That is to say, when it is to be determined whether the prism volume bounding the sub-triangle intersects the ray.

In some embodiments, the apparatus and techniques described above are implemented in a system including one or more integrated circuit (IC) devices (also referred to as integrated circuit packages or microchips), such as the AU 112 described above with reference to FIGS. 1-12. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A processing system, comprising:
an accelerator unit (AU) configured to:
generate a prism volume bounding a triangle of a displaced micro-mesh (DMM) based on an initial bounding volume associated with the triangle of the DMM; and
determine whether a ray intersects the prism volume bounding the triangle of the DMM.

2. The processing system of claim 1, wherein the triangle of the DMM is in a first level of a hierarchy indicated by the DMM.

3. The processing system of claim 2, wherein the AU is further configured to:
based on the ray not intersecting the prism volume bounding the triangle of the DMM, generate a second prism volume bounding a second triangle of the DMM based on a second initial bounding volume associated with the second triangle of the DMM, wherein the second triangle of the DMM is at the first level of the hierarchy indicated by the DMM.

4. The processing system of claim 2, wherein the AU is further configured to:
based on the ray intersecting the prism volume bounding the triangle of the DMM, generate a second prism volume bounding a second triangle of the DMM based on a second initial bounding volume associated with the second triangle of the DMM, wherein the second triangle of the DMM is in a second level of the hierarchy indicated by the DMM.

5. The processing system of claim 1, wherein the AU is configured to generate the prism volume by:
bounding one or more sides of the initial bounding volume with respective bounding volumes; and
combining the respective bounding volumes together with at least a portion of the initial bounding volume to form the prism volume.

6. The processing system of claim 5, wherein the at least a portion of the initial bounding volume comprises a first cap representing a minimum displacement of the triangle of the DMM and a second cap representing a maximum displacement of the triangle of the DMM.

7. The processing system of claim 1, wherein the AU is further configured to:
generate the initial bounding volume based on one or more displacement vectors associated with the triangle of the DMM.

8. The processing system of claim 1, wherein the AU is configured to generate the prism volume in response to receiving the DMM.

9. A method, comprising:
generating a prism volume bounding a triangle of a displaced micro-mesh (DMM) based on an initial bounding volume associated with the triangle of the DMM; and
determining whether a ray intersects the prism volume bounding the triangle of the DMM.

10. The method of claim 9, wherein the triangle of the DMM is in a first level of a hierarchy indicated by the DMM.

11. The method of claim 10, further comprising:
based on the ray not intersecting the prism volume bounding the triangle of the DMM, generating a second prism volume bounding a second triangle of the DMM based on a second initial bounding volume associated with the second triangle of the DMM, wherein the second triangle of the DMM is at the first level of the hierarchy indicated by the DMM.

12. The method of claim 10, further comprising:
based on the ray intersecting the prism volume bounding the triangle of the DMM, generating a second prism volume bounding a second triangle of the DMM based on a second initial bounding volume associated with the second triangle of the DMM, wherein the second triangle of the DMM is in a second level of the hierarchy indicated by the DMM.

13. The method of claim 9, wherein generating the prism volume comprises:
bounding one or more sides of the initial bounding volume with respective bounding volumes; and
combining the respective bounding volumes together with at least a portion of the initial bounding volume to form the prism volume.

14. The method of claim 13, wherein the at least a portion of the initial bounding volume comprises a first cap representing a minimum displacement of the triangle of the DMM and a second cap representing a maximum displacement of the triangle of the DMM.

15. The method of claim 9, further comprising:
generating the initial bounding volume based on one or more displacement vectors associated with the triangle of the DMM.

16. The method of claim 9, wherein generating the prism volume is in response to receiving the DMM.

17. An accelerator unit (AU), comprising:
a ray tracing circuitry configured to perform a ray tracing operation using a triangle of a displaced micro-mesh (DMM); and
a bounding circuitry configured to, in response to the ray tracing circuitry initiating the ray tracing operation, generate a prism volume bounding the triangle of the DMM based on a bounding volume associated with the triangle of the DMM.

18. The AU of claim 17, wherein the triangle of the DMM is in a first level of a hierarchy indicated by the DMM.

19. The AU of claim 18, wherein the bounding circuitry is further configured to:
based on the ray tracing circuitry determining a ray does not intersect the prism volume bounding the triangle of the DMM, generate a second prism volume bounding a second triangle of the DMM based on a second initial bounding volume associated with the second triangle of the DMM, wherein the second triangle of the DMM is at the first level of the hierarchy indicated by the DMM.

20. The AU of claim 18 wherein the bounding circuitry is further configured to:
based on the ray tracing circuitry determining a ray does intersect the prism volume bounding the triangle of the DMM, generate a second prism volume bounding a second triangle of the DMM based on a second initial bounding volume associated with the second triangle of the DMM, wherein the second triangle of the DMM is in a second level of the hierarchy indicated by the DMM.
